(19) United States
(12) Patent Application Publication
(10) Pub. No.: US 2010/0118850 A1
(43) Pub. Date: May 13, 2010

(54) Method and apparatus for transmitting data in wireless network

(76) Inventor: Jong Owan Kim, Hwaseong-si (KR)

Correspondence Address: STAAS & HALSEY LLP, SUITE 700, 1201 NEW YORK AVENUE, N.W., WASHINGTON, DC, 20005, US

(21) Appl. No.: 12/588,887

(22) Filed: Oct. 30, 2009

(30) Foreign Application Priority Data
Nov. 10, 2008 (KR) 10-2008-0111181

(51) Int. Cl. H04W 8/00

(52) U.S. Cl. 370/338

(57) ABSTRACT

A method and apparatus for transmitting data in a wireless network. A piconet coordinator transmits a frame, which is built by combining and capsulating a plurality of datagrams respectively corresponding to a plurality of devices, to the plurality of devices. Thus, since a time interval to ensure a frame header and an inter frame space (IFS) can be excluded, it is possible to improve transmission efficiency.

### CROSS-REFERENCE TO RELATED APPLICATIONS

This application claims the benefit of Korean Patent Application No. 10-2008-0111181, filed on Nov. 10, 2008 in the Korean Intellectual Property Office, the disclosure of which is incorporated herein by reference.

### BACKGROUND

1. Field

One or more embodiments relate to a method and apparatus for transmitting data in a wireless network, and, more particularly, to a method and apparatus for transmitting data in a wireless network capable of improving data transmission efficiency.

2. Description of the Related Art

Various digital products such as DVD players, digital TV (DTV) receivers, or personal computers (PCs) are being currently released or developed. Such digital products may be solely used or may be used in a state of being connected with one network.

Such a network is called a personal area network (PAN). The PAN is mainly established by a wired network such as a cable. With the development of wireless communication technology, a wireless PAN (WPAN) is gradually being increased.

Recently, a wireless network may be used between an upper-level controller (CPU) of a home robot and a lower-level controller (CPU) of a sensor module.

An example of a communication method for implementing the WPAN includes ultra wide band (UWB). The UWB indicates a wireless technology of transmitting a large amount of digital data using a wide spectral frequency with low power in a short distance range. In the IEEE 802.15.3 standard, a physical (PHY) layer and a medium access control (MAC) layer are described.

The IEEE 802.15.3 MAC is characterized in that a wireless network is rapidly established. In addition, while the existing wireless local area network (WLAN) is based on an access point (AP), the IEEE 802.15.3 MAC is based on an ad hoc network, which is called a piconet using a piconet coordinator (PNC).

### SUMMARY

Therefore, it is an aspect of one or more embodiments to provide a method and apparatus for transmitting data in a wireless network, which is capable of improving data transmission efficiency in a piconet.

Further, it is an aspect of one or more embodiments to provide a method and apparatus of improving data transmission efficiency in the WPAN by improving the IEEE 802.15.3 MAC.

Additional aspects and/or advantages will be set forth in part in the description which follows and, in part, will be obvious from the description, or may be learned by practice of the invention.

In accordance with one or more embodiments, the above and/or other aspects can be achieved by the provision of a method for transmitting data in a piconet which transmits a frame from a piconet coordinator to a plurality of devices, the method including generating a common frame for at least two devices by the piconet coordinator, transmitting the generated common frame, retrieving data from the common frame corresponding to each of the at least two devices, respectively by each of the at least two devices.

The piconet coordinator may periodically transmit the common frame.

The generating of the common frame may include capsulating a frame header commonly corresponding to the plurality of devices and a frame body obtained by combining a plurality of datagrams respectively corresponding to the plurality of devices.

The frame header may include a field to set a frame type and a destination identifier, the frame type may be set to a reserved value, and the destination identifier may be set to a broadcast identifier.

The plurality of datagrams may be combined without an empty space between neighbor datagrams.

Each of the datagrams may include a device identifier and a datagram body.

When an address of each of the devices is equal to the device identifier of each of the datagrams, data of the datagram body may be retrieved.

Information set in the frame header may be checked before each of the devices retrieves data from the datagram.

In accordance with another aspect of one or more embodiments, there is provided an apparatus for transmitting data in a piconet, the apparatus including a piconet coordinator to configure the piconet, generate a common frame for at least two devices and transmit the generated common frame, and a plurality of devices to configure the piconet and respectively retrieve data corresponding to each of the plurality of devices from the common frame.

The piconet coordinator may capsulate a frame header and a frame body so as to generate the common frame and combine a plurality of datagrams respectively corresponding to the plurality of devices so as to build the frame body.

The piconet coordinator may combine the plurality of datagrams without an empty space between neighbor datagrams.

The piconet coordinator may set a frame type of the frame header to a reserved value and set the destination identifier to a broadcast identifier.

Each of the plurality of devices has an address and may check information set in a frame header of the common frame before retrieving data of a corresponding datagram and read the data of the corresponding datagram upon the address being equal to a device identifier of the corresponding datagram.

According to one or more embodiments, there is provided a method for transmitting data including generating a common frame for a plurality of devices in a piconet, transmitting the generated common frame, and retrieving respectively by each of the devices, data from the common frame corresponding to each of the devices.

The generating of the common frame may be by a piconet coordinator.

The common frame may have a frame body formed by combining datagrams corresponding to each of the devices.

The datagrams may be combined in series in correspondence with each of the devices which will receive data.

The frame type of the common frame may be set to a super data frame, and a destination identifier of the common frame is set to a broadcast identifier.

The retrieving may include determining a destination identifier of the common frame to be set to a broadcast identifier, and a frame type of the common frame to be set to a super data frame.

The common frame format may include an MAC frame header and an MAC frame body, the MAC frame header having an IEEE 802.15.3 standard format, the MAC frame body being formed by combining datagrams corresponding with each of the devices which will receive data.

Since a system to control a plurality of devices at a predetermined interval of time like a home robot using the IEEE 802.15.3 WPAN combines data frames transmitted to the devices to a super data frame and transmits the super data frame, a time interval to ensure a frame header and an inter frame space (IFS) can be excluded. Accordingly, it is possible to prevent bandwidth waste due to the time interval and improve transmission efficiency.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates components of a piconet;

FIG. 2 illustrates the arrangement of frames transmitted from a piconet coordinator to a plurality of devices according to the IEEE 802.15.3 standard;

FIG. 3 illustrates the format of a general frame according to the IEEE 802.15.3 standard;

FIG. 4 illustrates the format of a super data frame according to an embodiment;

FIG. 5 is a flowchart illustrating a method of transmitting data from a piconet coordinator to a plurality of devices according to an embodiment; and

FIG. 6 is a flowchart illustrating a method of retrieving data from a frame received by a device according to an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

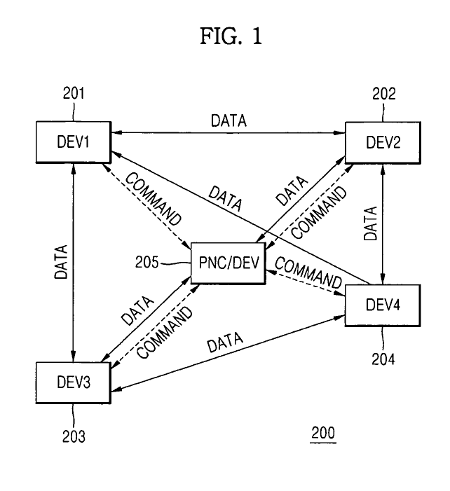

FIG. 1 illustrates components of a piconet.

An IEEE 802.15.3 piconet 200 includes a plurality of devices 201 to 205. The devices include a device having a special function, that is, a piconet coordinator (PNC) 205. The PNC serves to provide a basic timing for the piconet via a beacon. The PNC also manages quality of service (QoS), power reduction and connection management. Such a piconet is established when necessary, that is, a piconet exists as only an ad hoc network.

When data is transmitted between the PNC 205 and the devices 201 to 204, a frame which is built by applying a frame format according to the IEEE 802.15.3 standard is used. In the case where the PNC individually communicates with a specific device or otherwise, where the PNC communicates with a plurality of devices, the PNC may transmit control data to the specific device, or plurality of devices at a predetermined interval of time.

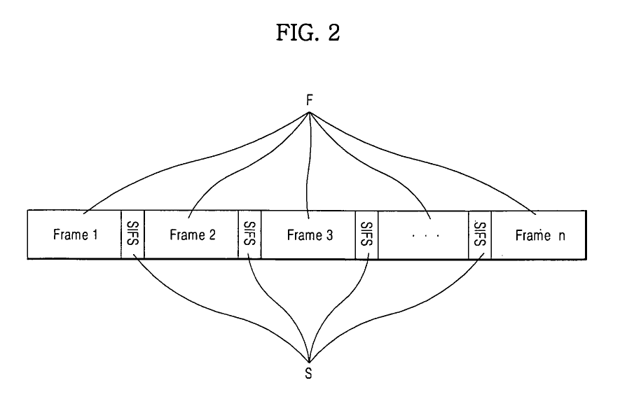

In the latter case, if the IEEE 802.15.3 standard is applied without alteration, as shown in FIG. 2, at the time of transmission of frames F corresponding to the plurality of devices, an empty space (short inter frame space; SIFS) S determined according to a physical (PHY) layer is arranged for the purpose of ensuring turnaround after one frame is transmitted. That is, the empty space S is arranged between the frames Frame 1, Frame 2, . . . , and Frame n. Accordingly, as the number of devices to which the data is transmitted from the PNC is increased, the number of empty spaces is increased. In addition, since a frame header is included in each frame, throughput deteriorates by a time consumed for processing the frame header as the number of frames is increased.

Such a problem may deteriorate transmission efficiency. For example, it is assumed that a home robot includes a large number of robot joints and actuators for moving the robot joints respectively mounted in sensor modules. An upper-level controller (CPU) for controlling the whole operation of the home robot may use a piconet in order to communicate with lower-level controllers (CPU) for controlling the sensor modules of the robot joints. In this case, the upper-level controller (CPU) becomes the PNC and the lower-level controllers (CPUs) become the devices. If a control command is sent from the upper-level controller (CPU) to the plurality of lower-level controllers (CPUs) at a predetermined interval of time, the empty space needs to be arranged between the frames as shown in FIG. 2. Thus, transmission efficiency may deteriorate in a restricted band.

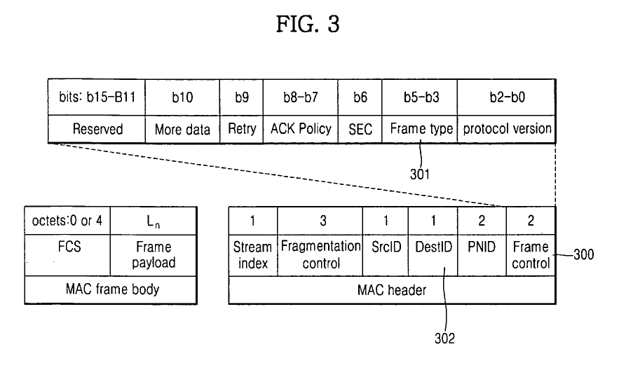

FIG. 3 illustrates the format of a general frame according to the IEEE 802.15.3 standard.

An MAC frame header includes a 21-byte frame control 300, a 2-byte piconet identifier (PNID), a 1-byte destination identifier (DestID), a 1-byte source identifier (SrcID), a 3-byte fragmentation control, and a 1-byte stream index. An MAC frame body includes a frame payload and a frame check sequence (FCS).

The frame control 300 includes a 3-bit protocol version field, a 3-bit frame type field 301, a 1-bit security field SEC, a 2-bit ACK policy field, a 1-bit retry field, and 1-bit more data field indicating whether or not the remaining time of channel time allocation (CTA) is used, and a 5-bit reserved field, all of which are arranged in this order.

The PNID includes a unique identifier for the piconet. The fragmentation control is used to fragmentize and recombine MAC service data units (MSDU) and command frames. The stream index indicates the kind of the stream.

The frame body includes a frame payload having a variable length to transmit information (data) to the devices in the piconet or a group of devices, and a FCS to detect an error in a process of transmitting a frame.

In one or more embodiments, it is possible to improve a frame format suitable for transmitting the data from the PNC to the plurality of devices in the piconet and improve data transmission efficiency using a frame generated according to the improved frame format.

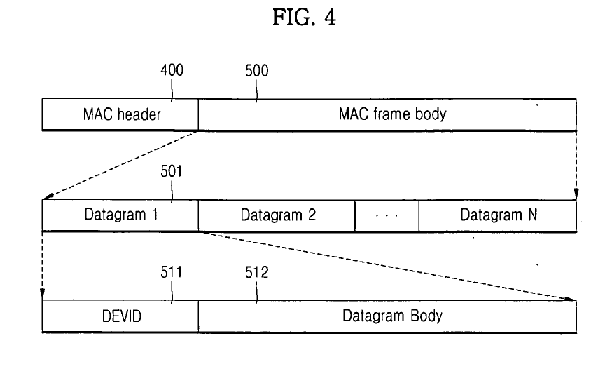

Accordingly, the frame type of the frame header and the destination identifier DestID are specially set, and the frame body is built so as to have a datagram having a format described in FIG. 4.

First, the PNC sets a destination identifier DestID field 302 of the frame header to a broadcast identifier BcstID.

The frame type field 301 is a 3-bit field belonging to the frame control field 300. The frame type field is shown in Table 1.

TABLE 1
Frame type

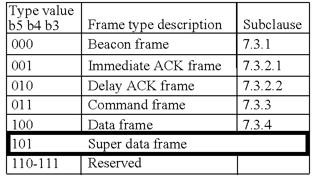

A frame type value “000” denotes a beacon frame, “001” denotes an immediate ACK frame, “010” denotes a delay ACK frame, “011” denotes a command frame, and “100” denotes a data frame.

According to the 802.15.3 standard, the frame type values “101” to “111” are reserved. However, in one or more embodiments, one of the reserved type values is specially used. That is, the frame type value “101” is used to define a super data frame as shown in Table 1. The setting of the frame type value to the super data frame indicates that the format of a frame including combined datagrams is used in a common frame header as shown in FIG. 4 when the data is transmitted from the PNC to the plurality of devices.

As shown in FIG. 4, the super data frame includes an MAC frame header 400 and an MAC frame body 500.

The format of the frame header 400 is equal to that of the frame shown in FIG. 3.

The frame body 500 is built by combining the datagrams Datagram 1, Datagram 2, Datagram 3, . . . , and Datagram N in series in correspondence with the number of devices which will receive the data. An empty space does not exist between a datagram corresponding to any one device and a datagram corresponding to a next device. Each datagram includes an identifier of a device and a datagram body corresponding to the device. As shown in FIG. 4, a first datagram 501 arranged next to the frame header 400 includes the identifier (DEVID) 511 of a device and a datagram body 512 corresponding to actual data. The configuration of the datagram 501 is equal to those of the datagrams Datagram 2, . . . , and Datagram N.

A method for transmitting data using an improved frame format is useful in a home robot using the IEEE 802.15.3 WPAN as a communication unit. That is, an upper-level controller of the robot functions as the PNC and a plurality of lower-level controllers function as the devices. Accordingly, it is possible to transmit data at a predetermined interval of time.

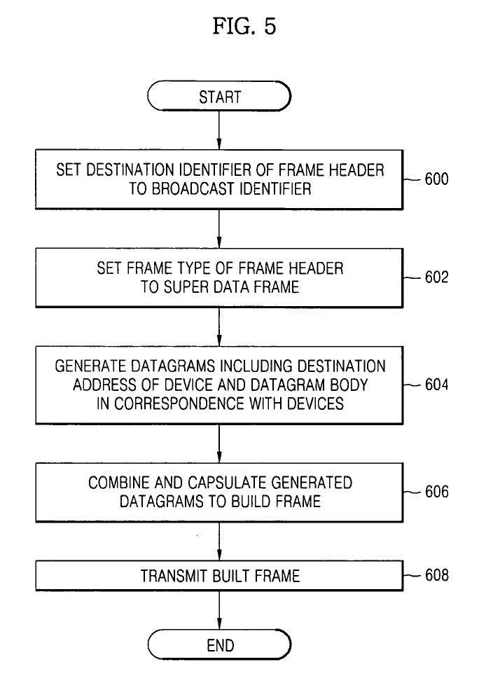

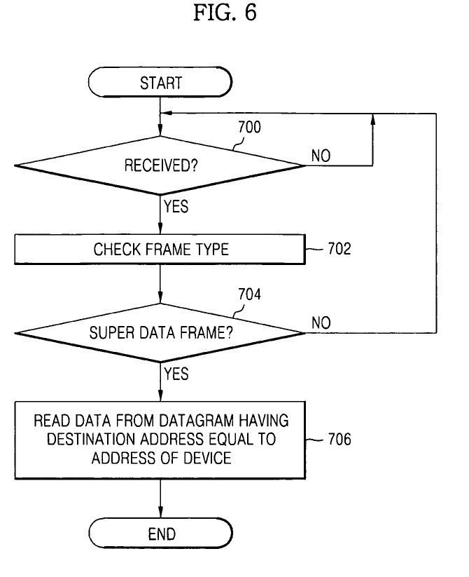

FIG. 5 is a flowchart illustrating a process of transmitting data from a PNC to a plurality of devices according to one or more embodiments, and FIG. 6 is a flowchart illustrating a process of retrieving data from a frame received by a device according to one or more embodiments.

Referring to FIG. 5, in operation 600, the PNC sets the destination identifier DestID of the frame header to a broadcast identifier BcstID. In operation 602, the frame type of the frame header is set to the super data frame, and the frame type value is set to 101 as shown in Table 1. The PNC to set transmission control information of the frame header generates datagrams with respect to the devices which will receive the data, such that one datagram corresponds to one device. In operation 604, each datagram includes a device identifier DEVID and a datagram body. Then, in operation 606, the plurality of datagrams generated by the devices are combined and are capsulated together with the frame header so as to build a frame. Then, the PNC transmits the built frame in operation 608.

Referring to FIG. 6, in operation 700, in the piconet, each of the devices determines whether or not the frame of the PNC is received. If the frame is received, in operation 702, each of the devices checks whether the destination identifier DestID of the frame header is set to the broadcast identifier BcstID, and in operation 704, each of the devices checks whether the frame type is set to the super data frame. If the frame is not received, operation 700 is repeated. If it is checked that the destination identifier DestID of the frame header is set to the broadcast identifier BcstID and the frame type is set to the super data frame, in operation 706, each of the devices reads data from a datagram, in which the device identifier DEVID is equal to its own address, among the plurality of datagrams combined in the super data frame. If it is determined that the frame type is not set to the super data frame, operation 700 is repeated.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method for transmitting data in a piconet which transmits a frame from a piconet coordinator to a plurality of devices, the method comprising:
generating a common frame for at least two devices by the piconet coordinator;
transmitting the generated common frame; and
retrieving data from the common frame corresponding to each of the at least two devices, respectively by each of the at least two devices.

2. The method according to claim 1, wherein the piconet coordinator periodically transmits the common frame.

3. The method according to claim 1, wherein the generating of the common frame includes capsulating a frame header commonly corresponding to the plurality of devices and a frame body obtained by combining a plurality of datagrams respectively corresponding to the plurality of devices.

4. The method according to claim 3, wherein the frame header includes a field to set a frame type and a destination identifier, the frame type is set to a reserved value, and the destination identifier is set to a broadcast identifier.

5. The method according to claim 3, wherein the plurality of datagrams are combined without an empty space between neighbor datagrams.

6. The method according to claim 3, wherein each of the datagrams includes a device identifier and a datagram body.

7. The method according to claim 6, wherein, when an address of each of the devices is equal to the device identifier of each of the datagrams, data of the datagram body is retrieved.

8. The method according to claim 3, wherein information set in the frame header is checked before each of the devices retrieves data from the datagram.

9. An apparatus for transmitting data in a piconet, the apparatus comprising:
a piconet coordinator to configure the piconet, generate a common frame for at least two devices and transmit the generated common frame; and
a plurality of devices to configure the piconet and respectively retrieve data corresponding to each of the plurality of devices from the common frame.

10. The apparatus according to claim 9, wherein the piconet coordinator capsulates a frame header and a frame body so as to generate the common frame and combines a plurality of datagrams respectively corresponding to the plurality of devices so as to build the frame body.

11. The apparatus according to claim 10, wherein the piconet coordinator combines the plurality of datagrams without an empty space between neighbor datagrams.

12. The apparatus according to claim 10, wherein the piconet coordinator sets a frame type of the frame header to a reserved value and sets the destination identifier to a broadcast identifier.

13. The apparatus according to claim 9, wherein each of the plurality of devices has an address and checks information set in a frame header of the common frame before retrieving data of a corresponding datagram and reads the data of the corresponding datagram upon the address being equal to a device identifier of the corresponding datagram.

14. A method for transmitting data comprising:
generating a common frame for a plurality of devices in a piconet;
transmitting the generated common frame; and
retrieving respectively by each of the devices, data from the common frame corresponding to each of the devices.

15. The method of claim 14 wherein the generating of the common frame is by a piconet coordinator.

16. The method of claim 14, wherein the common frame has a frame body formed by combining datagrams corresponding to each of the devices.

17. The method of claim 16, wherein the datagrams are combined in series in correspondence with each of the devices which will receive data.

18. The method of claim 14, wherein a frame type of the common frame is set to a super data frame, and a destination identifier of the common frame is set to a broadcast identifier.

19. The method of claim 14, wherein the retrieving includes determining a destination identifier of the common frame to be set to a broadcast identifier, and a frame type of the common frame to be set to a super data frame.

20. The method of claim 14, wherein the common frame format includes an MAC frame header and an MAC frame body, the MAC frame header having an IEEE 802.15.3 standard format, the MAC frame body being formed by combining datagrams corresponding with each of the devices which will receive data.
